(19) United States
(12) Patent Application Publication
(10) Pub. No.: US 2020/0050092 A1
(43) Pub. Date: Feb. 13, 2020

(54) COOLING DEVICE AND PROJECTOR

(71) Applicant: SEIKO EPSON CORPORATION, Tokyo (JP)

(72) Inventors: Katsuya SHIMIZU, Saku-shi (JP); Norio IMAOKA, Shimoina-gun (JP)

(73) Assignee: SEIKO EPSON CORPORATION, Tokyo (JP)

(21) Appl. No.: 16/537,656

(22) Filed: Aug. 12, 2019

(30) Foreign Application Priority Data
Aug. 13, 2018 (JP) 2018-152262

(51) Int. Cl. G03B 21/16; F25B 39/02

(52) U.S. Cl. CPC G03B 21/16; G03B 21/208; F25B 39/028

(57) ABSTRACT

A cooling device includes an evaporator for changing working fluid to a vapor phase, a condenser for changing the working fluid to a liquid phase, a vapor pipe, and a liquid pipe. The evaporator includes a housing having a reservoir configured to store the working fluid in the liquid phase, a first wick soaked with the working fluid in the liquid phase, a groove member disposed having a plurality of flow channels and connected to the first wick, and a second wick for transporting the working fluid in the liquid phase to the first wick. The second wick is an elastic body for pressing the first wick against the groove member. The second wick is located between the first wick and a first inner wall opposed to the first wick in an opposite direction to a direction in which the groove member is located with respect to the first wick.

The present application is based on, and claims priority from JP Application Serial Number 2018-152262, filed Aug. 13, 2018, the disclosure of which is hereby incorporated by reference herein in its entirety.

### BACKGROUND

### 1. Technical Field

The present disclosure relates to a cooling device and a projector.

### 2. Related Art

In the past, as a cooling device used for cooling of an electronic apparatus and so on, there has been known a loop heat pipe for transporting heat using a change of phase of a working fluid encapsulated inside (see, e.g., JP-A-2012-83082 (Document 1)).

The loop heat pipe described in Document 1 is provided with an evaporator, a condenser, a vapor pipe and a liquid pipe. The evaporator receives heat from a heat generator to evaporate the working fluid in the liquid phase to change the phase to the working fluid in the vapor phase. The vapor pipe makes the working fluid having changed to the vapor phase in the evaporator flow through the condenser. The condenser condenses the working fluid in the vapor phase due to heat radiation to change in phase to the working fluid in the liquid phase. The liquid pipe makes the working fluid having changed to the liquid phase in the condenser flow through the evaporator.

As described above, by the working fluid circulating in the loop heat pipe to transport the heat of the heat generator from the evaporator to the condenser and radiate the heat in the condenser, the heat generator is cooled.

It should be noted that in the loop heat pipe described in Document 1, the evaporator has a flat plate wick, a groove member disposed below the wick to form a vapor flow channel, and a housing for housing the wick and the groove member, and the heat generator is coupled to the housing.

The wick is formed of a porous material, and the working fluid in the liquid phase soaks into the wick from a liquid reservoir in the housing due to a capillary action. The working fluid in the liquid phase having soaked into the wick evaporates due to the heat transferred from the heat generator to change to the working fluid in the vapor phase, and the working fluid in the vapor phase flows through the vapor flow channel in the groove member, and then flows into the vapor pipe.

However, in the loop heat pipe described in Document 1, there is a problem that depending on the posture of the evaporator, the circulation efficiency of the working fluid decreases, and thus, the cooling efficiency of the heat generator decreases.

In the detailed description, a suction force on the working fluid in the liquid phase due to the capillary action of the wick creates a drive force on the working fluid in the loop heat pipe. Therefore, it is necessary for the wick to have contact with the working fluid in the liquid phase in the liquid reservoir. However, when the posture of the evaporator changes to cause the wick to fail to have contact with the working fluid in the liquid phase in the liquid reservoir, the wick fails to suction the working fluid in the liquid phase, and thus, the working fluid stops circulating.

Meanwhile, the phase change of the working fluid from the liquid phase to the vapor phase occurs in the groove member or the wick.

In order to cause the phase change in the groove member, it is necessary for the wick to transport the working fluid in the liquid phase from the liquid reservoir to the groove member. However, when the wick and the groove member fail to have contact with each other and are separated from each other, it becomes unachievable for the wick to transport the working fluid in the liquid phase to the groove member. In this case, it becomes unachievable to cause the phase change of the working fluid from the liquid phase to the vapor phase, and thus, the working fluid stops circulating.

In order to cause the phase change in the wick, it is necessary to transfer the heat of the heat generator to the wick via the groove member or the housing. However, when the wick and the groove member are separated from each other, it is unachievable to transfer the heat of the heat generator to the wick via the groove member, and further, even when the phase change occurs in the wick due to the heat transfer via the housing, it becomes difficult to make the working fluid in the vapor phase flow into the vapor flow channels of the groove member. Therefore, there is a problem that it is difficult to circulate the working fluid.

### SUMMARY

A cooling device according to a first aspect of the present disclosure includes an evaporator configured to evaporate working fluid in a liquid phase due to a heat transferred from a cooling target to change to the working fluid in a vapor phase, a condenser configured to condense the working fluid in the vapor phase to change to the working fluid in the liquid phase, a vapor pipe through which the working fluid changed to the vapor phase in the evaporator flow into the condenser, and a liquid pipe through which the working fluid changed to the liquid phase in the condenser flow into the evaporator, wherein the evaporator includes a housing to which the liquid pipe is connected, the housing into which the working fluid in the liquid phase inflows from the liquid pipe, the housing having a reservoir configured to store the working fluid in the liquid phase flowed into the reservoir, a first wick disposed in the housing, the first wick soaked with the working fluid in the liquid phase, a groove member disposed in the housing, the groove member having a plurality of flow channels through which the working fluid changed from the liquid phase to the vapor phase flows, the groove member connected to the first wick, and a second wick disposed in the reservoir, the second wick connected to the first wick, the second wick configured to transport the working fluid in the liquid phase stored in the reservoir to the first wick. The second wick is an elastic body and is configured to press the first wick against the groove member. The second wick is located between the first wick and a first inner wall out of inner walls of the housing, the first wall opposed to the first wick in an opposite direction to a direction in which the groove member is located with respect to the first wick.

In the first aspect described above, the second wick may be directly connected to the first wick.

In the first aspect described above, a shape of the second wick may be a tubular shape.

In the first aspect described above, the evaporator may have a sealing member configured to seal between the first wick and a second inner wall out of inner walls of the housing, the second inner wall surrounding the first wick when viewed from a direction in which the groove member is located with respect to the first wick.

A projector according to a second aspect of the present disclosure includes a light source configured to emit light, a light modulator configured to modulate the light emitted from the light source, a projection optical device configured to project the light modulated by the light modulator, and any one of the cooling devices described above.

In the second aspect of the present disclosure, the cooling target may be the light source.

### BRIEF DESCRIPTION OF THE DRAWINGS

FIG. 1 is a perspective view showing the appearance of a projector according to an embodiment of the present disclosure.

FIG. 2 is a schematic diagram showing an internal configuration of the projector in the embodiment.

FIG. 3 is a schematic diagram showing a configuration of a light source device in the embodiment.

FIG. 4 is a cross-sectional view showing an internal structure of an evaporator in the embodiment.

FIG. 5 is a cross-sectional view showing the evaporator changed in posture in the embodiment.

### DESCRIPTION OF EXEMPLARY EMBODIMENT

An embodiment of the present disclosure will hereinafter be described based on the accompanying drawings.

### Configuration of Projector

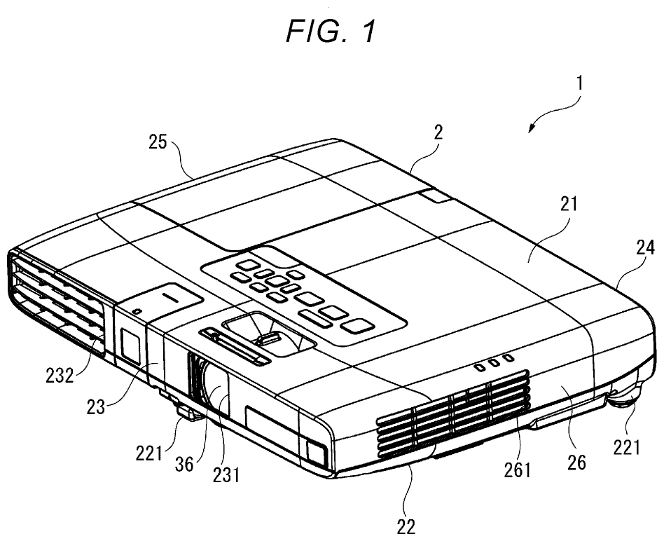

FIG. 1 is a perspective view showing the appearance of the projector 1 according to the present embodiment.

The projector 1 according to the present embodiment is an image display device for modulating the light emitted from a light source device 4 described later to form an image corresponding to image information, and then projecting the image thus formed on a projection target surface such as a screen in an enlarged manner. As shown in FIG. 1, the projector 1 is provided with an exterior housing 2 constituting the exterior of the projector 1.

### Configuration of Exterior Housing

An exterior housing 2 has a top surface part 21, a bottom surface part 22, a front surface part 23, a back surface part 24, a left side surface part 25 and a right side surface part 26, and is formed to have a substantially rectangular solid shape.

The bottom surface part 22 has a plurality of leg parts 221 having contact with an installation surface on which the projector 1 is mounted.

The front surface part 23 is located on the projection side of an image in the exterior housing 2. The front surface part 23 has an opening part 231 for exposing a part of a projection optical device 36 described later, and the image to be projected by the projection optical device 36 passes through the opening part 231. Further, the front surface part 23 has an exhaust port 232 from which a cooling gas having cooled the cooling target in the projector 1 is discharged to the outside of the exterior housing 2.

The right side surface part 26 has an introduction port 261 from which a gas such as air located outside the exterior housing 2 is introduced inside as a cooling gas.

### Internal Configuration of Projector

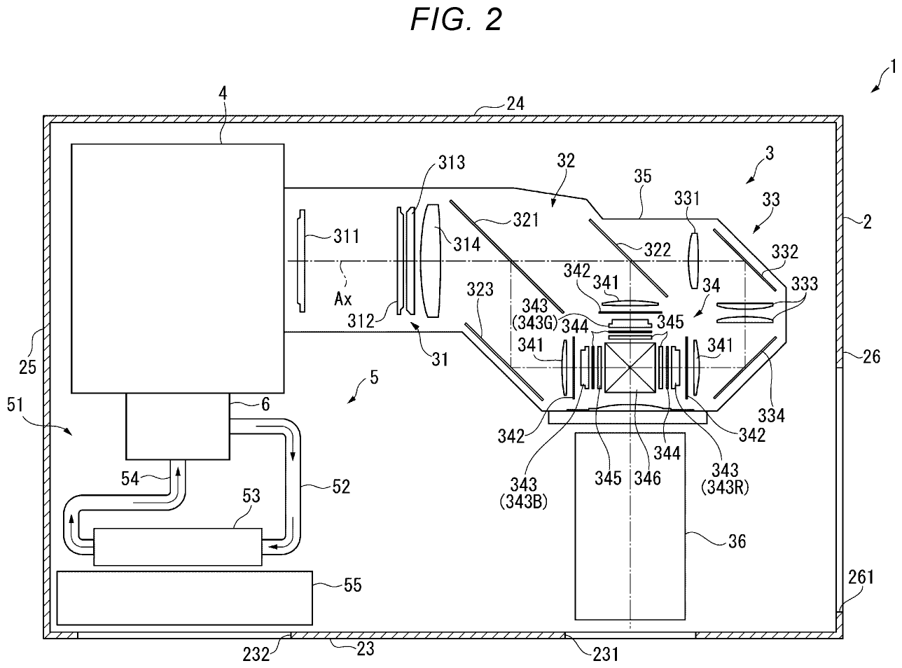

FIG. 2 is a schematic diagram showing an internal configuration of the projector 1.

As shown in FIG. 2, the projector 1 is further provided with an image projection device 3 and a cooling device 5 each housed inside the exterior housing 2. Besides the above, although not shown in the drawings, the projector 1 is provided with a control device for controlling an operation of the projector 1, and a power supply device for supplying electronic components of the projector 1 with electrical power.

### Configuration of Image Projection Device

The image projection device 3 forms and then projects the image corresponding to the image information input from the control device. The image projection device 3 is provided with a light source device 4, a homogenizing device 31, a color separation device 32, a relay device 33, an image forming device 34, an optical component housing 35 and a projection optical device 36.

The light source device 4 emits illumination light. A configuration of the light source device 4 will be described later in detail.

The homogenizing device 31 homogenizes the illumination light emitted from the light source device 4. The illumination light thus homogenized illuminates a modulation area of a light modulator 343 described later of the image forming device 34 via the color separation device 32 and the relay device 33. The homogenizing device 31 is provided with two lens arrays 311, 312, a polarization conversion element 313 and a superimposing lens 314.

The color separation device 32 separates the light having entered the color separation device 32 from the homogenizing device 31 into colored light beams of red, green and blue. The color separation device 32 is provided with two dichroic mirrors 321, 322, and a reflecting mirror 323 for reflecting the blue light beam having been separated by the dichroic mirror 321.

The relay device 33 is disposed on a light path of the red light beam longer than light paths of other colored light beams to suppress a loss of the red light beam. The relay device 33 is provided with an incident side lens 331, a relay lens 333 and reflecting mirrors 332, 334. It should be noted that in the present embodiment, it is assumed that the colored light beam longer in light path than other colored light beams is the red light beam, and the relay device 33 is disposed on the light path of the red light beam. However, this is not a limitation, and it is also possible to adopt a configuration in which, for example, the colored light beam longer in light path than other colored light beams is the blue light beam and the relay device 33 is disposed on the light path of the blue light beam.

The image forming device 34 modulates each of the colored light beams of red, green and blue having entered the image forming device 34, and combines the colored light beams thus modulated with each other to form the image. The image forming device 34 is provided with three field lenses 341, three incident side polarization plates 342, three light modulators 343, three view angle compensation plates 344 and three exit side polarization plates 345 each disposed in accordance with the respective colored light beams entering the image forming device 34, and a single color combining device 346.

The light modulators 343 each modulate the light emitted from the light source device 4 in accordance with the image information. The light modulators 343 includes the light modulator 343R for the red light beam, the light modulator 343G for the green light beam, and the light modulator 343B for the blue light beam. In the present embodiment, the light modulators 343 are each formed of a transmissive liquid crystal panel, and the incident side polarization plate 342, the light modulator 343 and the exit side polarization plate 345 constitute a liquid crystal light valve.

The color combining device 346 combines the colored light beams modulated by the light modulators 343B, 343G and 343R with each other to form the image. In the present embodiment, the color combining device 346 is formed of a cross dichroic prism, but this is not a limitation, and it is also possible for the color combining device 346 to be formed of a plurality of dichroic mirrors.

The optical component housing 35 houses the devices 31 through 34 described above inside. It should be noted that an illumination light axis Ax as a design optical axis is set to the image projection device 3, and the optical component housing 35 holds the devices 31 through 34 at predetermined positions on the illumination light axis Ax. It should be noted that the light source device 4 and the projection optical device 36 are disposed at predetermined positions on the illumination light axis Ax.

The projection optical device 36 projects the image entering the projection optical device 36 from the image forming device 34 on the projection target surface in an enlarged manner. In other words, the projection optical device 36 projects the light beams having respectively been modulated by the light modulators 343B, 343G and 343R. The projection optical device 36 is configured as a combination lens composed of a plurality of lenses housed in a lens tube having a cylindrical shape, for example.

### Configuration of Light Source Device

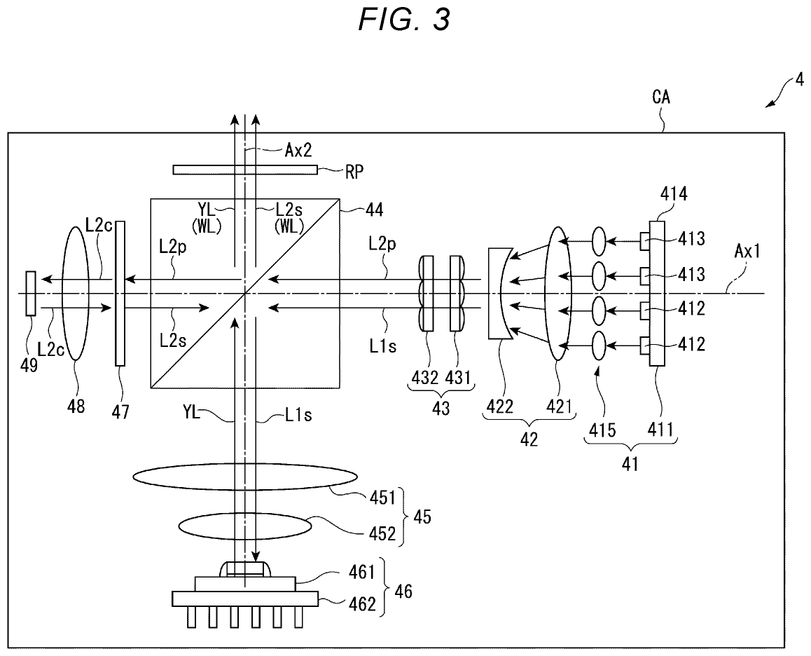

FIG. 3 is a schematic diagram showing a configuration of the light source device 4.

The light source device 4 emits the illumination light to the homogenizing device 31. As shown in FIG. 3, the light source device 4 is provided with a light source housing CA, and a light source unit 41, an afocal optical element 42, a homogenizer optical element 43, a polarization split element 44, a first light collection element 45, a wavelength conversion element 46, a first retardation element 47, a second light collection element 48, a diffusely reflecting device 49 and a second retardation element RP each housed inside the light source housing CA.

The light source housing CA is configured as a sealed housing difficult for dust or the like to enter the inside thereof.

The light source unit 41, the afocal optical element 42, the homogenizer optical element 43, the polarization split element 44, the first retardation element 47, the second light collection element 48 and the diffusely reflecting device 49 are arranged on an illumination light axis Ax1 set in the light source device 4.

The wavelength conversion element 46, the first light collection element 45, the polarization split element 44 and the second retardation element RP are set in the light source device 4, and are arranged on an illumination light axis Ax2 perpendicular to the illumination light axis Ax1.

### Configuration of Light Source Unit

The light source unit 41 is provided with a light source 411 for emitting the light, and a collimator lens 415.

The light source 411 is provided with a plurality of first semiconductor lasers 412 and a plurality of second semiconductor lasers 413, and a support member 414.

The first semiconductor lasers 412 each emit blue light L1s, which is s-polarized light, as excitation light. The blue light L1s is, for example, a laser beam with a peak wavelength of 440 nm. The blue light L1s having been emitted from the first semiconductor lasers 412 enters the wavelength conversion element 46.

The second semiconductor lasers 413 each emit blue light L2p, which is p-polarized light. The blue light L2p is, for example, a laser beam with a peak wavelength of 460 nm. The blue light L2p having been emitted from the second semiconductor lasers 413 enters the diffusely reflecting device 49.

The support member 414 supports the plurality of first semiconductor lasers 412 and the plurality of second semiconductor lasers 413 each arranged in an array in a plane perpendicular to the illumination light axis Ax1. The support member 414 is a metal member having thermal conductivity, and is connected to an evaporator 6 described later, and the heat of each of the semiconductor lasers 412, 413, namely the light source 411, as the heat source is transferred to the evaporator 6.

The blue light L1s having been emitted from the first semiconductor lasers 412 and the blue light L2p having been emitted from the second semiconductor lasers 413 are converted by the collimator lens 415 into a parallel light beam, and then enter the afocal optical element 42.

It should be noted that in the present embodiment, the light source 411 has a configuration of emitting the blue light L1s as the s-polarized light and the blue light L2p as the p-polarized light. However, this is not a limitation, and the light source 411 can also be provided with a configuration of emitting a blue light beam which is a linearly polarized light beam the same in polarization direction. In this case, it is sufficient to dispose a retardation element, which changes one type of linearly polarized light having entered the retardation element to light including s-polarized light and p-polarized light, between the light source unit 41 and the polarization split element 44.

### Configuration of Afocal Optical Element and Homogenizer Optical Element

The afocal optical element 42 adjusts the beam diameter of the blue light L1s, L2p which enters the afocal optical element 42 from the light source unit 41, and then makes the blue light L1s, L2p enter the homogenizer optical element 43. The afocal optical element 42 is constituted by a lens 421 for collecting the incident light, and a lens 422 for collimating the light beam collected by the lens 421.

The homogenizer optical element 43 homogenizes the illuminance distribution of the blue light L1s, L2p. The homogenizer optical element 43 is formed of a pair of multi-lens arrays 431, 432.

### Configuration of Polarization Split Element

The blue light L1s, L2p having been transmitted through the homogenizer optical element 43 enters the polarization split element 44.

The polarization split element 44 is a prism-type polarization beam splitter, and separates an s-polarization component and a p-polarization component included in the incident light from each other. Specifically, the polarization split element 44 reflects the s-polarization component, and transmits the p-polarization component. Further, the polarization split element 44 has a color separation characteristic of transmitting light with the wavelength no shorter than a predetermined wavelength irrespective of whether the light is the s-polarization component or the p-polarization component. Therefore, the blue light L1s as the s-polarized light is reflected by the polarization split element 44, and enters the first light collection element 45. Meanwhile, the blue light L2p as the p-polarized light is transmitted through the polarization split element 44, and enters the first retardation element 47.

### Configuration of First Light Collection Element

The first light collection element 45 converges the blue light L1s having been reflected by the polarization split element 44 on the wavelength conversion element 46. Further, the first light collection element 45 collimates fluorescence YL entering the first light collection element 45 from the wavelength conversion element 46. Although the first light collection element 45 is constituted by two lenses 451, 452 in the example shown in FIG. 3, the number of lenses constituting the first light collection element 45 does not matter.

### Configuration of Wavelength Conversion Element

The wavelength conversion element 46 is excited by the incident light to generate the fluorescence YL longer in wavelength than the incident light, and emits the fluorescence YL to the first light collection element 45. In other words, the wavelength conversion element 46 converts the wavelength of the incident light, and emits the light thus converted. The fluorescence YL generated by the wavelength conversion element 46 is, for example, light with the peak wavelength in a range of 500 through 700 nm. The wavelength conversion element 46 is provided with a wavelength converter 461 and a heat radiator 462.

Although not shown in the drawings, the wavelength converter 461 has a wavelength conversion layer and a reflecting layer. The wavelength conversion layer includes a phosphor for diffusely emitting the fluorescence YL as non-polarized light obtained by performing the wavelength conversion on the incident blue light L1s. The reflecting layer reflects the fluorescence YL entering the reflecting layer from the wavelength conversion layer toward the first light collection element 45.

The heat radiator 462 is disposed on a surface on an opposite side to the incident side of light in the wavelength converter 461 to radiate the heat generated in the wavelength converter 461.

The fluorescence YL having been emitted from the wavelength conversion element 46 passes through the first light collection element 45 along the illumination light axis Ax2, and then enters the polarization split element 44 having the color separation characteristic described above. Then, the fluorescence YL passes through the polarization split element 44 along the illumination light axis Ax2, and then enters the second retardation element RP.

It should be noted that the wavelength conversion element 46 can also be provided with a configuration of being rotated around a rotational axis parallel to the illumination light axis Ax2 by a rotation device such as a motor.

### Configuration of First Retardation Element and Second Light Collection Element

The first retardation element 47 is disposed between the polarization split element 44 and the second light collection element 48. The first retardation element 47 converts the blue light L2p having passed through the polarization split element 44 into blue light L2c as circularly polarized light. The blue light L2c enters the second light collection element 48.

The second light collection element 48 converges the blue light L2c entering the second light collection element 48 from the first retardation element 47 on the diffusely reflecting device 49. Further, the second light collection element 48 collimates the blue light L2c entering the second light collection element 48 from the diffusely reflecting device 49. It should be noted that the number of lenses constituting the second light collection element 48 can arbitrarily be changed.

### Configuration of Diffusely Reflecting Device

The diffusely reflecting device 49 diffusely reflects the incident blue light L2c at substantially the same diffusion angle as that of the fluorescence YL generated in and emitted from the wavelength conversion element 46. As a configuration of the diffusely reflecting device 49, there can be illustrated a configuration provided with a reflecting plate for performing Lambertian reflection on the incident blue light L2c and a rotation device for rotating the reflecting plate around a rotational axis parallel to the illumination light axis Ax1.

The blue light L2c having diffusely been reflected by the diffusely reflecting device 49 passes through the second light collection element 48, and then enters the first retardation element 47. The blue light L2c is converted into circularly polarized light with the opposite rotational direction when reflected by the diffusely reflecting device 49. Therefore, the blue light L2c having entered the first retardation element 47 via the second light collection element 48 is not converted into the blue light L2p as the p-polarized light at the moment when having entered the first retardation element 47 from the polarization split element 44, but is converted into the blue light L2s as the s-polarized light. Then, the blue light L2s is reflected by the polarization split element 44 to enter the second retardation element RP. Therefore, the light which enters the second retardation element RP from the polarization split element 44 is white light having the blue light L2s and the fluorescence YL mixed with each other.

### Configuration of Second Retardation Element

The second retardation element RP converts the white light entering the second retardation element RP from the polarization split element 44 into light having s-polarized light and p-polarized light mixed with each other. The illumination light WL as the white light converted in such a manner enters the homogenizing device 31 described above.

### Configuration of Cooling Device

The cooling device 5 cools a cooling target constituting the projector 1. In the present embodiment, the cooling target is the light source 411 of the light source device 4. As shown in FIG. 2, the cooling device 5 is provided with a loop heat pipe 51 and a cooling fan 55.

The cooling fan 55 is disposed between the exhaust port 232 and a condenser 53 described later of the loop heat pipe 51 in the space inside the exterior housing 2. The cooling fan 55 makes cooling air flow through the condenser 53 in the process of suctioning the cooling air inside the exterior housing 2 to discharge the cooling air from the exhaust port 232, and thus, cools the condenser 53. It should be noted that it is also possible to adopt a configuration in which, for example, the cooling fan 55 is disposed between the introduction port 261 and the condenser 53 described later in the space inside the exterior housing 2, suctions the cooling air located outside the exterior housing 2 to feed the cooling air to the condenser 53.

The loop heat pipe 51 has a circulation channel for circulating the working fluid, which is encapsulated in a reduced pressure state to thereby be changed in phase state at a relatively low temperature. In the detailed description, the loop heat pipe 51 causes the phase change of the phase state of the working fluid encapsulated inside in the reduced pressure state from the liquid phase to the vapor phase due to the heat transferred from the cooling target to draw the heat from the working fluid in the vapor phase with a region other than regions where the phase change of the working fluid from the liquid phase to the vapor phase has occurred to thereby change the phase state of the working fluid from the vapor phase to the liquid phase, and at the same time, radiates the heat thus drawn to thereby cool the cooling target.

Such a loop heat pipe 51 is provided with the evaporator 6, a vapor pipe 52, the condenser 53 and a liquid pipe 54. It should be noted that a configuration of the evaporator 6 will be described later in detail.

### Configuration of Vapor Pipe

The vapor pipe 52 is a tubular member for coupling the evaporator 6 and the condenser 53 to each other in the circulation channel of the working fluid so that the working fluid in the vapor phase can flow. The vapor pipe 52 makes the working fluid in the vapor phase, which has changed to the vapor phase in the evaporator 6 and then flows from the evaporator 6 into the vapor pipe 52, flow into the condenser 53.

### Configuration of Condenser

The condenser 53 draws the heat of the working fluid in the vapor phase to thereby radiate the heat thereof, and thus, changes the working fluid in phase from the vapor phase to the liquid phase, and then makes the working fluid in the liquid phase flow out to the liquid pipe 54. In other words, the condenser 53 condenses the working fluid in the vapor phase to change the working fluid in the vapor phase to the working fluid in the liquid phase. Although not shown in the drawings, the condenser 53 has a main body part to which the vapor pipe 52 and the liquid pipe 54 are connected, and a heat radiator connected to the main body part.

The main body part has a phase change flow channel inside, wherein the working fluid in the vapor phase inflowing from the vapor pipe 52 flows through the phase change flow channel, and the phase change flow channel is communicated with the liquid pipe 54. The heat of the working fluid in the vapor phase is received by the main body part and thus the working fluid is cooled in the process in which the working fluid in the vapor phase flows through the phase change flow channel, and thus, the working fluid in the vapor phase is changed to the working fluid in the liquid phase. Then, the working fluid having been changed in phase to the liquid phase further flows through the phase change flow channel and cooled by the main body part receiving the heat of the working fluid in the liquid phase, and then flows out to the liquid pipe 54.

The heat radiator is a member for radiating the heat of the working fluid having been transferred to the main body part, and is a so-called heatsink. Through the heat radiator, the cooling gas flows due to the drive of the cooling fan 55, and thus, the condenser 53 is cooled.

### Configuration of Liquid Pipe

The liquid pipe 54 is a tubular member for coupling the condenser 53 and the evaporator 6 to each other in the circulation channel of the working fluid so that the working fluid in the liquid phase can flow. The liquid pipe 54 makes the working fluid having changed to the liquid phase in the condenser 53 flow into the evaporator 6.

### Configuration of Evaporator

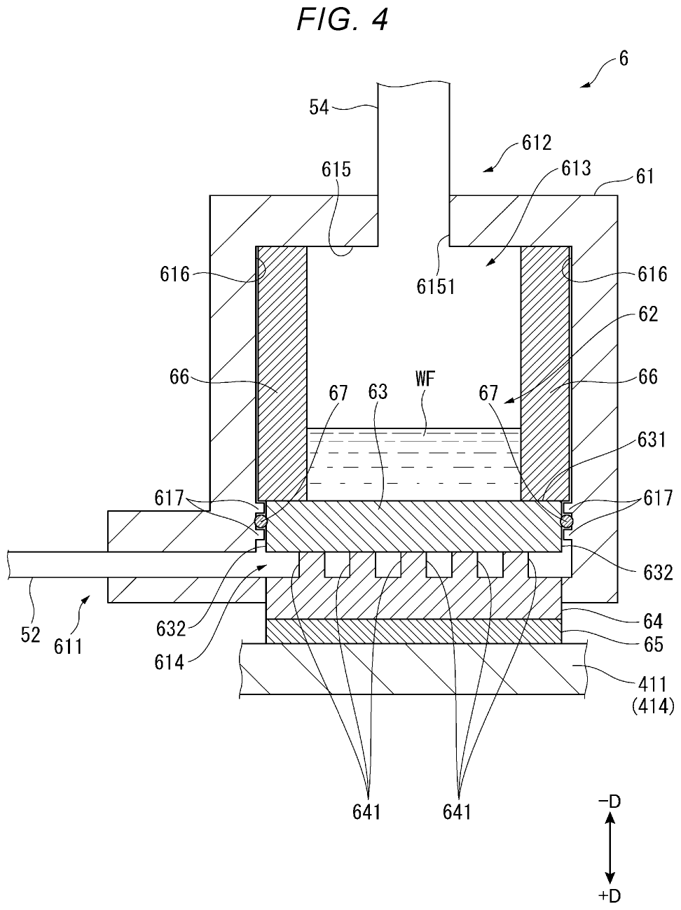

FIG. 4 is a cross-sectional view showing an internal structure of the evaporator 6.

As shown in FIG. 2, the evaporator 6 is an evaporator which is connected to the light source 411 as the cooling target, and evaporates the working fluid in the liquid phase due to the heat transferred from the light source 411 to be changed to the working fluid in the vapor phase. Specifically, the evaporator 6 is connected to the support member 414 of the light source 411, and evaporates the working fluid in the liquid phase with the heat of the semiconductor lasers 412, 413 transferred via the support member 414 to thereby cool the semiconductor lasers 412, 413.

As shown in FIG. 4, the evaporator 6 is provided with a housing 61, a reservoir 62, a first wick 63, a groove member 64, a heat receiving member 65, a second wick 66 and a sealing member 67.

The housing 61 is a housing made of metal, and has a vapor pipe connector 611 to which the vapor pipe 52 is connected, and a liquid pipe connector 612 which is located on the opposite side to the vapor pipe connector 611, and to which the liquid pipe 54 is connected. Besides the above, the housing 61 has a space 613 formed inside by being combined with the groove member 64. The space 613 is communicated with the vapor pipe 52 via the vapor pipe connector 611, and is communicated with the liquid pipe 54 via the liquid pipe connector 612. In other words, to the housing 61, there is connected the liquid pipe 54, and the working fluid in the liquid phase inflows into the space 613 inside the housing 61 from the liquid pipe 54.

The space 613 is formed by closing a recessed part 614 opening in an end part on the vapor pipe connector 611 side with the groove member 64, and forms the reservoir 62 for storing the working fluid in the liquid phase. In the space 613, there are disposed the first wick 63, the second wick 66 and the sealing member 67. The recessed part 614 forming such a space 613 is formed of a first inner wall 615 and a second inner wall 616 constituting the inner wall of the housing 61.

The first inner wall 615 is formed to have a substantially circular flat shape. The first inner wall 615 is provided with an opening part 6151 communicated with the liquid pipe 54 connected to the liquid pipe connector 612.

The second inner wall 616 vertically hangs down or erects from an outer edge of the first inner wall 615. The second inner wall 616 is provided with a holder 617 for holding the sealing member 67 by clamping, wherein the sealing member 67 is disposed along a circumferential direction of the second inner wall 616.

It should be noted that in the following description, a direction from the groove member 64 toward the first inner wall 615, namely the depth direction of the recessed part 614, is defined as a −D direction, and an opposite direction to the −D direction is defined as a +D direction. In other words, the +D direction is a direction in which the groove member 64 is located with respect to the first wick 63, and the −D direction is an opposite direction to the direction in which the groove member 64 is located with respect to the first wick 63. Further, the +D direction is also a direction in which the working fluid in liquid phase inflows into the space 613 from the opening part 6151 located in the first inner wall 615 via the liquid pipe 54.

The reservoir 62 is disposed inside the housing 61 to store the working fluid WF in the liquid phase flowing into the space 613 via the liquid pipe 54. In other words, the reservoir 62 is a region in which the working fluid WF in the liquid phase having failed to be suctioned by the first wick 63 or the second wick 66 is stored in the space 613.

The first wick 63 is a plate-like porous body which is disposed inside the housing 61, and into which the working fluid in the liquid phase soaks. The first wick 63 transports the working fluid in the liquid phase which has contact with the first wick 63, or the working fluid in the liquid phase which has been transported to the first wick 63 by the second wick 66 out of the working fluid WF in the liquid phase stored in the reservoir 62 toward the groove 64 with the capillary force. The first wick 63 is formed of a metal fiber made of, for example, copper or stainless steel, or a material such as glass.

The groove member 64 is formed of metal having thermal conductivity. The groove member 64 is provided to the housing 61, and is connected to the first wick 63. The groove member 64 evaporates the working fluid in the liquid phase having been transported by the first wick 63 with the heat transferred from the cooling target via the heat receiving member 65, namely the heat transferred from the light source 411 via the support member 414 and the heat receiving member 65. The groove member 64 has a plurality of flow channels 641 through which the working fluid having changed form the liquid phase to the vapor phase flows, and the plurality of flow channels 641 is communicated with the vapor pipe 52. The working fluid having been changed from the liquid phase to the vapor phase flows out to the vapor pipe 52 through the plurality of flow channels 641.

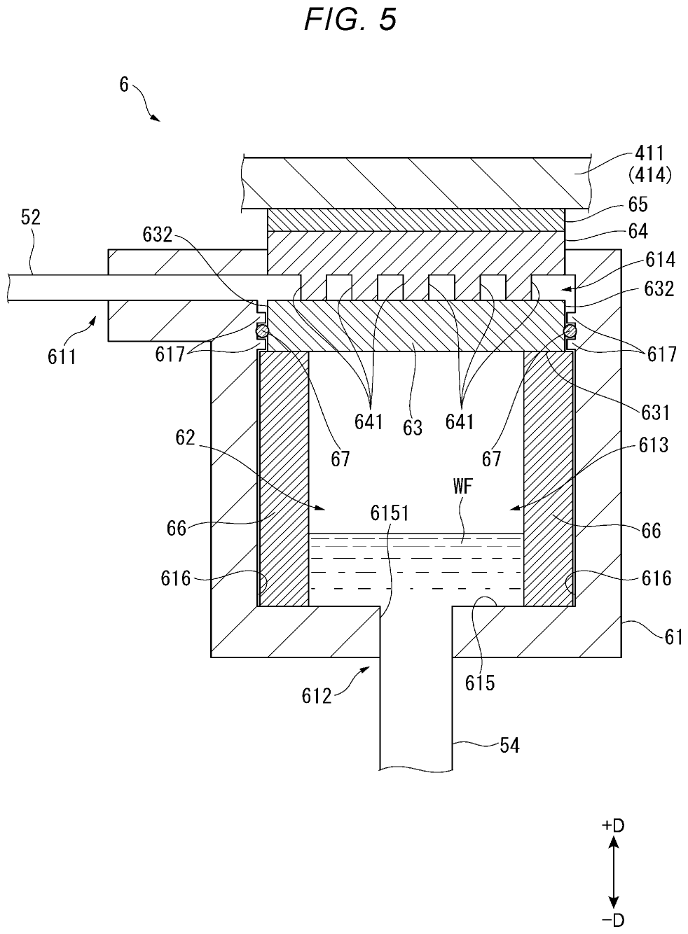

It should be noted that although the detailed illustration is omitted in FIG. 4, the plurality of flow channels 641 extends in a direction perpendicular to the +D direction such as a direction perpendicular to the sheet of FIG. 4, and an end of each of the flow channels 641 and the vapor pipe 52 are communicated with each other. Therefore, the working fluid in the vapor phase flowing through the plurality of flow channels 641 flows out to the vapor pipe 52. It should be noted that the fact that the plurality of flow channels 641 and the vapor pipe 52 are communicated with each other also applies to FIG. 5 described later.

The heat receiving member 65 is connected to the support member 414 of the light source 411 as the cooling target of the loop heat pipe 51 to transfer the heat generated in the semiconductor lasers 412, 413 to the groove member 64.

The second wick 66 is a porous body which is disposed inside the reservoir 62, and into which the working fluid in the liquid phase soaks. The second wick 66 is connected to the first wick 63. In the detailed description, the second wick 66 is disposed between the first wick 63 and the first inner wall 615 opposed to the first wick 63 in an opposite direction (−D direction) to the direction in which the groove member 64 is disposed with respect to the first wick 63 out of the inner walls of the housing 61. The second wick 66 transports the working fluid WF in the liquid phase stored in the reservoir 62 to the first wick 63 connected to the second wick 66. Further, the second wick 66 presses the first wick 63 against the groove member 64. Therefore, the second wick 66 is an elastic body capable of suctioning the working fluid WF in the liquid phase stored in the reservoir 62 with the capillary force to transport the working fluid to the first wick 63, and capable of pressing the first wick 63.

Such a second wick 66 is formed to have a tubular shape such as a cylindrical shape, and is directly connected to the first wick 63. In the detailed description, in the second wick 66, an end part on the −D direction side has contact with the first inner wall 615, and an end part on the +D direction side has contact with a surface 631 on the −D direction side in the first wick 63. It should be noted that the second wick 66 is formed of a metal fiber made of, for example, copper or stainless steel.

The sealing member 67 is disposed between the first wick 63 and the second inner wall 616 surrounding the first wick 63 when viewed from the +D direction as the direction in which the groove member 64 is located with respect to the first wick 63 out of the inner walls of the housing 61, and seals a space between the first wick 63 and the second inner wall 616. In other words, the sealing member 67 seals the space between the first wick 63 and the second inner wall 616 to be connected to the first wick 63 out of the inner walls of the housing 61.

Specifically, the sealing member 67 is held by the holder 617 located on the second inner wall 616 surrounding the first wick 63 when viewed from the +D direction, and has contact with a circumferential surface 632 forming an outer edge of the first wick 63 when viewed from the +D direction. The sealing member 67 seals the space between the second inner wall 616 and the circumferential surface 632 to prevent the working fluid WF in the liquid phase in the reservoir 62 from flowing into the flow channels 641 along the second inner wall 616 without passing the first wick 63. Such a sealing member 67 can be formed of, for example, an O-ring.

Here, the sealing member 67 is held by being clamped from the +D direction and the −D direction by the holder 617. Therefore, even when the first wick 63 having contact with the sealing member 67 is pressed in the +D direction by the second wick 66, the pressing force toward the +D direction by the second wick 66 does not directly act on the sealing member 67. In other words, the second wick 66 does not have contact with the sealing member 67. Thus, it is possible to prevent the working fluid WF in the liquid phase from flowing toward the groove member 64 between the second inner wall 616 and the first wick 63 due to the displacement of the sealing member 67.

### Function of Evaporator

The working fluid WF in the liquid phase suctioned from the reservoir 62 or the second wick 66 with the capillary action has soaked into the first wick 63. Meanwhile, to the groove member 64, there is transferred the heat of the cooling target via the heat receiving member 65. Further, since the second wick 66 presses the first wick 63 against the groove member 64, the first wick 63 and the groove member 64 adhere to each other.

When the thermal conductivity of the first wick 63 is relatively high, the heat having been transferred to the groove member 64 is transferred to the first wick 63, and the working fluid in the liquid phase evaporates inside the first wick 63.

When the thermal conductivity of the first wick 63 is relatively low, the heat having been transferred to the groove member 64 is hard to be transferred to the first wick 63. In this case, the working fluid in the liquid phase having been transported by the first wick 63 flows to the groove member 64, and then evaporates on surfaces of the flow channels 641 in the groove member 64.

As described above, due to the heat transferred from the cooling target, the working fluid in the liquid phase changes to the working fluid in the vapor phase in at least any of regions inside the first wick 63 and regions on the surfaces of the groove member 64. The working fluid having changed in phase state to the vapor phase flows through the plurality of flow channels 641 into the vapor pipe 52, and then reaches the condenser 53 via the vapor pipe 52.

### When Turning Evaporator Upside Down

FIG. 5 is a cross-sectional view showing another posture of the evaporator 6. In other words, FIG. 5 is a cross-sectional view showing the internal configuration of the evaporator 6 changed in posture form the state shown in FIG. 4.

The projector 1 can be installed in, for example, either one of a normal installation posture in which the top surface part 21 faces to the upper side in the vertical direction, and a reverse installation posture in which the bottom surface part 22 faces to the upper side in the vertical direction. Further, for example, in the case in which the evaporator 6 becomes in the state shown in FIG. 4 when the posture of the projector 1 is the normal installation posture, when the posture of the projector 1 is changed to the reverse installation posture, the evaporator 6 becomes in the state shown in FIG. 5. In the posture shown in FIG. 5, the first wick 63 is located on the lower side in the vertical direction with respect to the groove member 64, and the second wick 66 is located on the lower side in the vertical direction with respect to the first wick 63. In other words, the +D direction indicates the downside in the vertical direction in FIG. 4, while the −D direction indicates the downside in the vertical direction in FIG. 5.

In such a posture shown in FIG. 5, the first wick 63 fails to have contact with the working fluid WF in the liquid phase stored in the reservoir 62. Therefore, when the second wick 66 is absent, since the working fluid in the liquid phase fails to soak into the first wick 63, the working fluid does not circulate through the loop heat pipe 51, and thus, it is unachievable to radiate the heat of the cooling target in the condenser 53. Specifically, in such a case, it is unachievable to efficiently cool the cooling target.

In contrast, in the reservoir 62, there is disposed the second wick 66 having contact with the first wick 63 so as to be able to transport the working fluid WF in the liquid phase, and the second wick 66 presses the first wick 63 against the groove member 64. Therefore, the working fluid WF in the liquid phase stored in the reservoir soaks into the second wick 66 due to the capillary force of the second wick 66, and is transported to the first wick 63 via the second wick 66.

Thus, the first wick 63 becomes in the state of being soaked with the working fluid in the liquid phase, and therefore, the working fluid in the liquid phase evaporates due to the heat of the cooling target transferred to the groove member 64, and thus, the working fluid in the vapor phase flows into the vapor pipe 52 via the flow channels 641 as described above.

It should be noted that in the state in which the evaporator 6 is rotated 90° clockwise or counterclockwise from the state shown in FIG. 4 or the state shown in FIG. 5, the working fluid in the liquid phase stored in the reservoir 62 is directly suctioned by the first wick 63, and is also suctioned by the second wick 66.

Therefore, whatever the posture of the projector 1, it is possible to make the working fluid WF in the liquid phase stored in the reservoir 62 soak into the first wick 63, and it is possible to achieve the phase change from the working fluid in the liquid phase to the working fluid in the vapor phase with the heat of the cooling target. Therefore, it is possible to prevent the deterioration of the circulation efficiency of the working fluid due to the fact that the working fluid in the liquid phase fails to be transported to the first wick 63 in the loop heat pipe 51, and thus, it is possible to effectively cool the cooling target.

### Advantages of Embodiment

The projector 1 according to the present embodiment described hereinabove provides the following advantages.

The loop heat pipe 51 constituting the cooling device 5 is provided with the evaporator 6, the condenser 53, the vapor pipe 52 and the liquid pipe 54, wherein the evaporator 6 evaporates the working fluid in the liquid phase with the heat transferred from the light source 411 as the cooling target to thereby change to the working fluid in the vapor phase, the condenser 53 condenses the working fluid in the vapor phase to thereby change to the working fluid in the liquid phase, the vapor pipe 52 makes the working fluid having changed in the evaporator 6 to one in the vapor phase flow into the condenser 53, and the liquid pipe 54 makes the working fluid having changed in the condenser 53 to one in the liquid phase flow into the evaporator 6. The evaporator 6 is provided with the housing 61, the reservoir 62, the first wick 63, the groove member 64 and the second wick 66, wherein the liquid pipe 54 is connected to the housing 61, the working fluid in the liquid phase inflows into the housing 61 from the liquid pipe 54, the reservoir 62 is disposed in the housing 61 and stores the working fluid in the liquid phase in flowing into the reservoir 62, the first wick 63 is disposed in the housing 61, and is soaked with the working fluid in the liquid phase, the groove member 64 is disposed in the housing 61, and has the plurality of flow channels 641 through which the working fluid having changed from the liquid phase to the vapor phase flows, and is connected to the first wick 63, the second wick 66 is disposed in the reservoir 62, and is connected to the first wick 63 to transport the working fluid in the liquid phase in the reservoir 62 to the first wick 63. The second wick 66 is the elastic body for pressing the first wick 63 against the groove member 64, and is located between the first wick 63 and the first inner wall 615 opposed to the first wick 63 in the −D direction as the opposite direction to the direction in which the groove member 64 is located with respect to the first wick 63 out of the inner walls of the housing 61.

According to this configuration, even when the posture of the projector 1 is changed, and thus, the posture of the evaporator 6 is changed, for example, from the state shown in FIG. 4 to the state shown in FIG. 5, it is possible to transport the working fluid WF in the liquid phase stored in the reservoir 62 to the first wick 63 via the second wick 66. Further, in other postures, the working fluid WF in the liquid phase stored in the reservoir 62 is directly suctioned by the first wick 63. Therefore, it is possible to soak the first wick 63 with the working fluid WF in the liquid phase irrespective of the posture of the evaporator 6 and the projector 1. Therefore, it is possible to change the working fluid in the liquid phase to the working fluid in the vapor phase with the heat of the light source 411 as the cooling target, and thus, it is possible to prevent the deterioration of the circulation efficiency of the working fluid due to the fact that the working fluid in the liquid phase fails to be transported to the first wick 63 in the loop heat pipe 51, and thus, it is possible to effectively cool the light source 411 as the cooling target.

Further, the second wick 66 is the elastic body having contact with the first inner wall 615 opposed to the first wick 63 in the −D direction out of the inner walls of the housing 61, and the surface 631 in the −D direction in the first wick 63 to press the first wick 63 against the groove member 64. According to this configuration, it is possible to make the first wick 63 and the groove member 64 adhere to each other.

Therefore, since it is possible to transport the working fluid in the liquid phase from the first wick 63 to the groove member 64, it is possible to cause the phase change of the working fluid from the liquid phase to the vapor phase on the surfaces of the groove member 64.

Further, since the first wick 63 and the groove member 64 adhere to each other, even when the phase change of the working fluid occurs inside the first wick 63, it is possible to make the heat of the cooling target which has been transferred to the groove member 64 easy to transfer to the first wick 63.

Besides the above, it is possible to make the working fluid in the vapor phase generated on the surfaces of the groove member 64 or in the first wick 63 easy to flow into the flow channels 641 of the groove member 64.

Thus, it is possible to make it easy to cause the phase change of the working fluid from the liquid phase to the vapor phase with the heat of the cooling target, and in addition, it is possible to make the working fluid in the vapor phase thus generated easy to flow into the vapor pipe 52. Therefore, it is possible to promptly transfer the heat of the cooling target to the condenser 53. Therefore, it is possible to enhance the cooling efficiency of the light source 411 as the cooling target.

The second wick 66 is directly connected to the surface 631 of the first wick 63. According to this configuration, it is possible to make it easy to transport the working fluid in the liquid phase from the second wick 66 to the first wick 63 compared to when a member through which the working fluid in the liquid phase can flow intervenes between the second wick 66 and the first wick 63. Therefore, it is possible to make it easy to soak the first wick 63 with the working fluid in the liquid phase.

The shape of the second wick 66 is a tubular shape. According to this configuration, it is possible to ensure the large contact area between the second wick 66 and the first wick 63 disposed in the reservoir 62 while ensuring the retention capacity of the working fluid in the liquid phase in the reservoir 62. Therefore, it is possible to promptly transport the working fluid in the liquid phase from the second wick 66 to the first wick 63, and further, it is possible to make the pressing force by the second wick 66 evenly act on the first wick 63.

The evaporator 6 is provided with the sealing member 67 for sealing the space between the circumferential surface 632 of the first wick 63 and the second inner wall 616 surrounding the first wick 63 when viewed from the +D direction as the direction in which the groove member 64 is located with respect to the first wick 63 out of the inner walls of the housing 61. According to this configuration, it is possible to prevent the working fluid in the liquid phase from flowing toward the groove member 64 between the second inner wall 616 and the first wick 63. Therefore, it is possible to prevent the working fluid from flowing into the vapor pipe 52 via the flow channels 641, and further, it is possible to prevent the working fluid in the liquid phase from being excessively supplied from the first wick 63 to the groove member 64, and therefore, it is possible to make the working fluid having been changed to one in the vapor phase due to the heat of the cooling target efficiently flow into the vapor pipe 52.

The projector 1 is provided with the light source 4, the light modulators 343, the projection optical device 36 and the cooling device 5 described above, wherein the light source device 4 has the light source 411 for emitting the light, the light modulators 343 each modulate the light emitted from the light source device 4, and the projection optical device 36 projects the light modulated by the light modulators 343. Further, the cooling target by the loop heat pipe 51 is the light source 411. According to this configuration, since it is possible to prevent the deterioration of the circulation efficiency of the working fluid, and further, it is possible to enhance the cooling efficiency of the light source 411 as described above, it is possible to stably operate the projector 1.

### Modifications of Embodiments

The present disclosure is not limited to the embodiment described above, but includes modifications, improvements, and so on in the range where the purpose of the present disclosure can be achieved.

In the embodiment described above, it is assumed that the second wick 66 is directly connected to the first wick 63. In other words, it is assumed that the second wick 66 has contact with the first wick 63. However, this is not a limitation, and it is also possible for a member not hindering the transport of the working fluid in the liquid phase from the second wick 66 to the first wick 63 to be disposed so as to intervene between the second wick 66 and the first wick 63. For example, the coupling between the second wick 66 and the first wick 63 includes the state in which a member not hindering the transport of the working fluid in the liquid phase, in other words, a member through which the working fluid in the liquid phase can flow, intervenes between the second wick 66 and the first wick 63. In other words, it is sufficient for the second wick 66 to be connected to the first wick 63 so as to be able to transport the working fluid in the liquid phase.

In the embodiment described above, it is assumed that the second wick 66 is formed to have a tubular shape. In the detailed description, it is assumed that the second wick 66 is formed to have the cylindrical shape fitting the inner edge shape of the reservoir 62 and the outer edge shape of the first wick 63. However, this is not a limitation, and it is also possible for the second wick 66 to have other shapes such as a rectangular tubular shape.

Further, it is also possible to form the second wick 66 having a cylindrical shape by combining a plurality of semicylindrical porous bodies with each other, or by rolling up a plate-like porous body to fit into the space 613.

Further, it is also possible for the second wick 66 to have other shapes such as a rod-like shape providing the second wick 66 can transport the working fluid in the liquid phase stored in the reservoir 62 to the first wick 63, and can press the first wick 63 against the groove member 64.

In the embodiment described above, it is assumed that in the second wick 66, the end part on the −D direction side has contact with the first inner wall 615 in which the opening part 6151 communicated with the liquid pipe 54 is located, and the end part on the +D direction side has contact with the surface 631 on the −D direction side in the first wick 63. However, this is not a limitation, and it is sufficient for the inner wall of the housing 61 which the end part on the −D direction side in the second wick 66 has contact with to be an inner wall opposed to the first wick 63 in the −D direction, and it is sufficient for the second wick 66 to partially be located in the reservoir 62, and to be able to press the first wick 63 against the groove member 64.

In the embodiment described above, it is assumed that the heat receiving member 65 for making it easy to transfer the heat having been generated in the light source 411 to the groove member 64 is disposed between the support member 414 of the light source 411 as the cooling target and the groove member 64. However, this is not a limitation, and it is also possible for the support member 414 and the groove member 64 to be connected to each other so as to be able to transfer heat without the intervention of the heat receiving member 65.

In the embodiment described above, it is assumed that the evaporator 6 has the sealing member 67 for preventing the working fluid in the liquid phase from flowing toward the groove member 64 between the circumferential surface 632 of the first wick 63 and the second inner wall 616 surrounding the first wick 63 when viewed from the +D direction. However, this is not a limitation, and the sealing member 67 can be eliminated. Further, the sealing member 67 is not limited to the O-ring, but can be a member having other configurations providing the function described above can be realized.

In the embodiment described above, it is assumed that the light source 411 of the light source device 4 has the semiconductor lasers 412, 413. However, this is not a limitation, and it is also possible for the light source device to be a device having a light source lamp such as a super-high pressure mercury lamp, or other solid-state light sources such as light emitting diodes (LED) as the light source. In this case, the cooling target of the loop heat pipe 51 can also be the light source lamp or other solid-state light sources.

In the embodiment described above, it is assumed that the projector 1 is equipped with the three light modulators 343 (343B, 343G and 343R). However, this is not a limitation, and the present disclosure can also be applied to a projector equipped with two or less, or four or more light modulators.

In the embodiment described above, it is assumed that the light modulators 343 are each the transmissive liquid crystal panel having the plane of incidence of light and the light exit surface different from each other. However, this is not a limitation, and it is also possible to use reflective liquid crystal panels having the plane of incidence of light and the light exit surface coinciding with each other as the light modulators. Further, it is also possible to use a light modulator other than the liquid crystal device, such as a device using a micromirror such as a digital micromirror device (DMD) providing the light modulator is capable of modulating the incident light beam to form the image corresponding to the image information.

In the embodiment described above, there is cited an example of applying the cooling device 5 equipped with the loop heat pipe 51 to the projector 1. However, this is not a limitation, and the cooling device according to the present disclosure can also be applied to other devices or equipment than the projector, and in addition, can also be used alone. In other words, the application of the cooling device according to the present disclosure is not limited to a device for cooling the constituents of the projector.

What is claimed is:

1. A cooling device comprising:
an evaporator configured to evaporate working fluid in a liquid phase due to a heat transferred from a cooling target to change to the working fluid in a vapor phase;
a condenser configured to condense the working fluid in the vapor phase to change to the working fluid in the liquid phase;
a vapor pipe through which the working fluid changed to the vapor phase in the evaporator flow into the condenser; and
a liquid pipe through which the working fluid changed to the liquid phase in the condenser flow into the evaporator, wherein:
the evaporator includes
a housing to which the liquid pipe is connected, the housing into which the working fluid in the liquid phase inflows from the liquid pipe, the housing having a reservoir configured to store the working fluid in the liquid phase flowed into the reservoir,
a first wick disposed in the housing, the first wick soaked with the working fluid in the liquid phase,
a groove member disposed in the housing, the groove member having a plurality of flow channels through which the working fluid changed from the liquid phase to the vapor phase flows, the groove member connected to the first wick, and
a second wick disposed in the reservoir, the second wick connected to the first wick, the second wick configured to transport the working fluid in the liquid phase stored in the reservoir to the first wick,
the second wick is an elastic body and is configured to press the first wick against the groove member, and
the second wick is located between the first wick and a first inner wall out of inner walls of the housing, the first inner wall opposed to the first wick in an opposite direction to a direction in which the groove member is located with respect to the first wick.

2. The cooling device according to claim 1, wherein
the second wick is directly connected to the first wick.

3. The cooling device according to claim 1, wherein
a shape of the second wick is a tubular shape.

4. The cooling device according to claim 1, wherein
the evaporator has a sealing member configured to seal between the first wick and a second inner wall out of inner walls of the housing, the second inner wall surrounding the first wick when viewed from a direction in which the groove member is located with respect to the first wick.

5. A projector comprising:
a light source configured to emit light;
a light modulator configured to modulate the light emitted from the light source;
a projection optical device configured to project the light modulated by the light modulator; and
the cooling device according to claim 1.

6. A projector comprising:
a light source configured to emit light;
a light modulator configured to modulate the light emitted from the light source;
a projection optical device configured to project the light modulated by the light modulator; and
the cooling device according to claim 2.

7. A projector comprising:
a light configured to emit light;
a light modulator configured to modulate the light emitted from the light source;
a projection optical device configured to project the light modulated by the light modulator; and
the cooling device according to claim 3.

8. A projector comprising:
a light source configured to emit light;
a light modulator configured to modulate the light emitted from the light source;
a projection optical device configured to project the light modulated by the light modulator; and
the cooling device according to claim 4.

9. The projector according to claim 5, wherein
the cooling target is the light source.

10. The projector according to claim 6, wherein
the cooling target is the light source.

11. The projector according to claim 7, wherein
the cooling target is the light source.

12. The projector according to claim 8, wherein
the cooling target is the light source.
